(19) United States
(12) Patent Application Publication
(10) Pub. No.: US 2025/0233504 A1
(43) Pub. Date: Jul. 17, 2025

(54) HIGH PERFORMANCE AND HIGH POWER MULTI-PATH HYBRID POWER STAGE

(71) Applicant: TEXAS INSTRUMENTS INCORPORATED, Dallas, TX (US)

(72) Inventors: Reza Sharifi, Sunnyvale, CA (US); Ramesh Balan, San Jose, CA (US)

(21) Appl. No.: 18/742,881

(22) Filed: Jun. 13, 2024

Related U.S. Application Data
(60) Provisional application No. 63/620,252, filed on Jan. 12, 2024.

(51) Int. Cl. H02M 1/00; H02M 3/07; H02M 3/158

(52) U.S. Cl. CPC H02M 1/0095; H02M 1/007; H02M 3/07; H02M 3/1582

(57) ABSTRACT

An apparatus includes a first converter circuit with a first output terminal and a second output terminal. The apparatus includes a second converter circuit with a first input terminal and a second input terminal and a third output terminal. A first connection connects the first output terminal to the first input terminal. A second connection connects the second output terminal to the second input terminal. The apparatus also includes a direct current (DC) decoupling component that is connected between the first connection and the second connection. The DC decoupling component DC decouples a signal between the first connection and the second connection.

### RELATED APPLICATIONS

The instant application is a nonprovisional patent application that claims the benefit and priority to the U.S. Provisional Application No. 63/620,252, filed on Jan. 12, 2024, which is incorporated herein by reference in its entirety.

### BACKGROUND

High power applications have increased in recent years. For example, the increase in the number of electric vehicles, computers, and smartphones has resulted in an increased number of high-power applications such as battery charging. High efficiency and fast charging is desirable for battery charging applications. Unfortunately, the power and size for inductors are limited for certain applications, e.g., mobile applications.

Some conventional systems have used converters (e.g., hybrid converters with switching capabilities) to deliver higher power and at a higher efficiency using smaller inductors. In certain applications, two or more converters have been arranged in a cascaded configuration to achieve high efficiencies. A converter may be a multi-phase converter such as dual phase converter. Unfortunately, the conventional configuration does not allow each phase of a converter to be operated independent of the other phase(s). For example, the conventional configuration does not allow the converter to operate in a single-phase buck mode and a single-phase boost mode, simultaneous boost for each phase, simultaneous buck for each phase, etc.

Moreover, two or more converters are generally controlled independent of one another. For example, the output voltage of the first converter is controlled independent of the output voltage of the second converter, thereby requiring control for each converter individually and independent of one another.

### SUMMARY

In an example, an apparatus includes a first converter circuit, a second converter circuit, and a direct current (DC) decoupling component. The first converter circuit has a first output terminal and a second output terminal. The second converter circuit has a first input terminal and a second input terminal and a third output terminal. A first connection connects the first output terminal to the first input terminal and a second connection connects the second output terminal to the second input terminal. The DC decoupling component is connected between the first connection and the second connection. The DC decoupling component DC decouples a signal between the first connection and the second connection.

In at least one example, an apparatus includes a buck/boost converter, a charge pump converter, and a capacitor. The buck/boost converter and the charge pump converter are cascaded with one another. A first terminal of the capacitor is connected to a first output terminal of a first cascaded converter circuit and a second terminal of the capacitor is connected to a second output terminal of the first cascaded converter circuit. The first output terminal of the first cascaded converter circuit is a first input to a second cascaded converter circuit and the second output terminal of the first cascaded converter is a second input to the second cascaded converter circuit.

### BRIEF DESCRIPTION OF THE DRAWINGS

FIGS. 1A-1B are schematic diagram of a system with multiphase converters where mode of operation for each phase is independent of the other phase, in an example.

FIGS. 2A-2B is a schematic diagram of multiphase converters where mode of operation for each phase is independent of the other phase, in an example.

FIG. 3 is a schematic diagram of a cascaded multiphase converter, in an example.

FIG. 4 is a schematic diagram of complementary charge pump for each phase of a cascaded multiphase converters, in an example.

FIG. 5 is a schematic diagram of a feedback loop controlling the output voltage of a cascaded multiphase converters by regulating the output current from an initial and/or intermediate converter in the cascaded multiphase converters, in an example.

FIGS. 6-9 is the operation of each phase of the cascaded multiphase converters, in an example.

FIGS. 10-11 are schematic diagrams of the cascaded multiphase converters and a current flow, in an example.

### DETAILED DESCRIPTION

The same reference numbers or other reference designators are used in the drawings to designate the same or similar (either by function and/or structure) features.

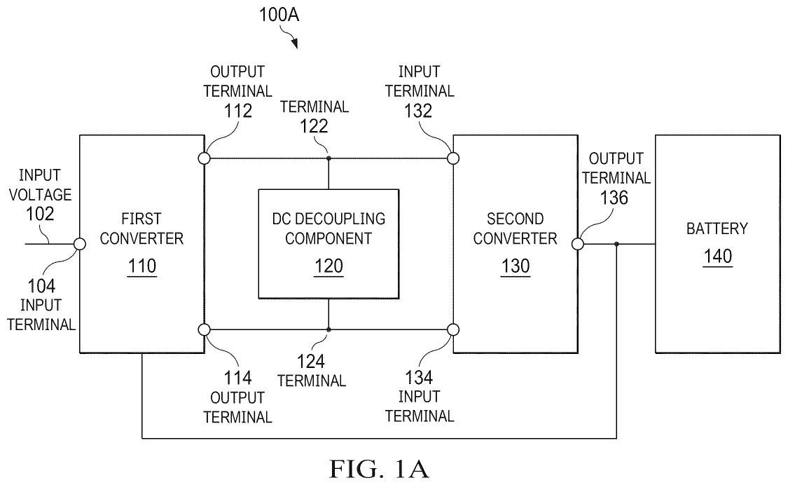

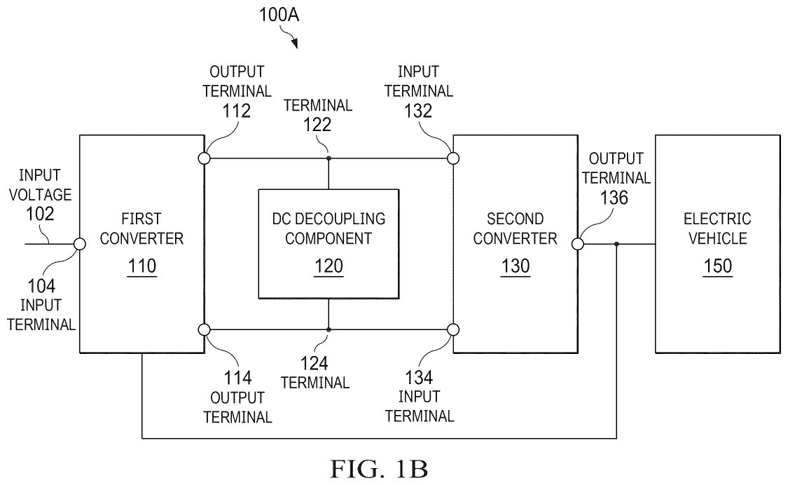

Hybrid converters or cascaded multiphase converters have been used to improve efficiency using smaller inductors at lower switching frequencies. For example, a multiphase buck/boost converter may be cascaded with a charge pump or another buck/boost converter, as an example. It may be desirable to allow multiple power path options, e.g., buck, boost, etc., for cascaded multiphase converters without increasing the number of switches or without impacting efficiency and/or the size of the die. For example, it may be desirable to allow one phase of the cascaded multiphase converters to boost while another phase operates in a buck mode, or to allow two phases to operate in boost mode (independently or simultaneously), or allow two phases to operate in buck mode (independently or simultaneously), etc. The examples below are described with respect to dual phase cascaded converters for illustration purposes and should not be construed as limiting the scope. For example, cascaded three-phase converters may also benefit from the architecture that will be described in FIGS. 1A-11.

Moreover, the examples illustrate a single control loop that is used to regulate the output voltage by regulating the intermediate current inputs to the converters instead of regulating the intermediate output voltage of the conventional cascaded converters. As a result, the current loop gain may be increased by a known factor, improving the system.

According to an example, a first converter circuit (e.g., multiphase converter) is cascaded with a second converter circuit (e.g., multiphase converter, charge pump, etc.). The first converter circuit may have two or more output terminals and the second converter circuit may have two or more input terminals. In an example, the first output terminal of the first converter circuit connected to the first input terminal of the second converter circuit and corresponds to a first phase. The second output terminal of the first converter circuit is connected to the second input terminal of the second converter circuit and corresponds to a second phase. The first output terminal of the first converter circuit is connected to the first input terminal of the second converter circuit via a first node and the second output terminal of the first converter circuit is connected to the second input terminal of the second converter circuit via a second node. The first node is connected to the second node via a direct current (DC) decoupling component, e.g., a capacitor. The DC decoupling component DC decouples the first phase from the second phase, thereby enabling multiple power path options for the cascaded multiphase converters.

FIG. 1A is a schematic diagram of a system 100A with multiphase converters where mode of operation for each phase is independent of the other phases, in an example. A first converter 110 circuit is coupled to a second converter 130 circuit in a cascaded configuration. The second converter 130 circuit may be coupled to a battery 140 and used in regulating the charging of the battery 140. The battery 140 may be used in smartphone, laptop, etc. The first converter 110 circuit and the second converter 130 circuit may be a buck/boost converter (to step up/down the voltage as desired), a charge pump converter, etc. Two cascaded converter circuitries are shown for illustration purposes and should not be construed as limiting the scope. For example, three or more converters may similarly be cascaded with one another. In one example, the first converter 110 circuit and the second converter 130 circuit may each include two or more phases.

In one example, the first converter 110 circuit includes an input terminal 104 that receives a signal with an input voltage 102. The first converter 110 circuit may include at least two output terminals, e.g., output terminals 112 and 114, where each output terminal corresponds to a phase associated with the first converter 110 circuit. According to one example, a DC decoupling component 120 is connected to the first and the second output terminals 112/114 of the first converter 110 circuit. For example, a DC decoupling component 120 may have a first terminal 122 that is connected to the first output terminal 112 of the first converter 110 circuit and a second terminal 124 that is connected to the second output terminal 114 of the first converter 110 circuit. In one example, a voltage at the first terminal 122 of the DC decoupling component 120 is associated with the output signal from the output terminal 112 (in phase one) and an output voltage at the second terminal 124 of the DC decoupling component 120 is associated with the output signal from the output terminal 114 (in phase two).

The first terminal 122 of the DC decoupling component 120 is connected to the input terminal 132 of the second converter 130 circuit. The second terminal 124 of the DC decoupling component 120 is connected to the input terminal 134 of the second converter 130 circuit. The second converter 130 circuit has an output terminal 136 for outputting a signal to the battery 140. The signal being sent to the battery 140 may regulate the charging of the battery 140. The output signal from the output terminal 136 may be fed back to the first converter 110 circuit.

In a traditional system, the voltage output of each converter is regulated based on its input independently. Moreover, traditional system is incapable of allowing one phase of the cascaded multiphase converters to boost while another phase operates in a buck mode, or to allow two phases to operate in a boost mode (independently or simultaneously), or allow two phases to operate in a buck mode (independently or simultaneously), etc., because the output terminals of the first converter in the conventional system are connected to one another and shorted to ground, sometimes via a capacitor.

According to one example, connecting the terminal 122 of the DC decoupling component 120 to the output terminal 112 of the first converter 110 circuit and further to the input terminal 132 of the second converter 130 circuit, and connecting the terminal 124 of the DC decoupling component 120 to the output terminal 114 of the first converter 110 circuit and further to the input terminal 134 of the second converter 130 circuit decouple the DC component from the output from the output terminal 112 and output terminal 114. As such, the cascaded converters may operate in multiple power paths, e.g., one phase of the cascaded multiphase converters to boost while another phase operates in a buck mode, or to allow two phases to operate in boost mode (independently or simultaneously), or allow two phases to operate in buck mode (independently or simultaneously), etc. According to one example, DC decoupling, as described above, also enables the output voltage from the final converter circuitry (e.g., second converter 130 circuit) of the cascaded circuitry to be controlled using a single control loop by regulating the current generated for each phase of the first converter 110 circuit rather than having to regulate the output voltage by regulating each intermediate voltage (e.g., voltage associated with output from each converter circuit).

FIG. 1B shows a system 100B that is similar to system 100A. In this example, the output from the second converter 130 circuit is input to an electric vehicle 150, e.g., battery or batteries of the electric vehicle 150.

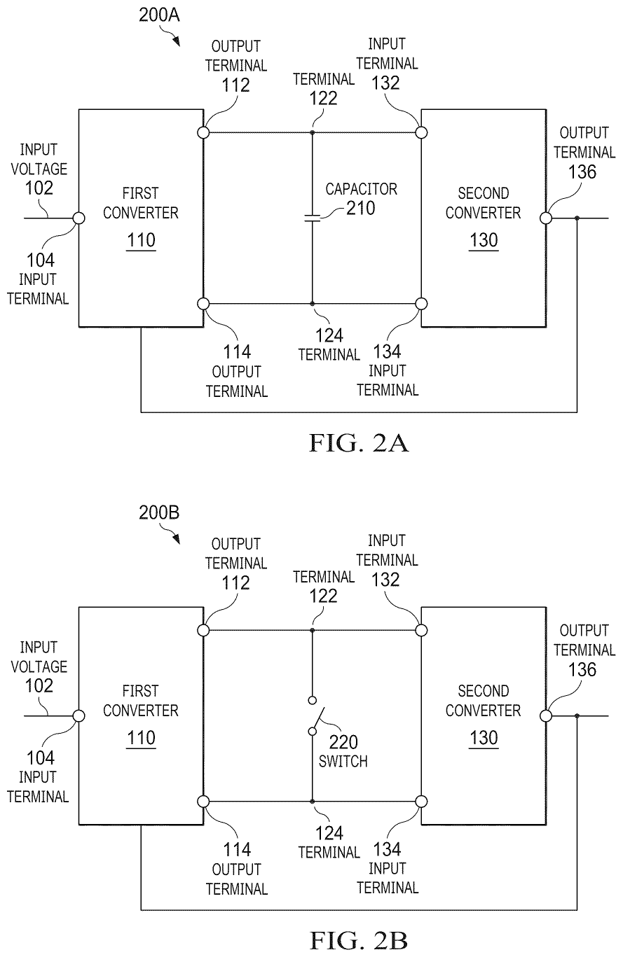

FIG. 2A is a schematic diagram of multiphase converters 200A in which mode of operation for each phase is independent of the other phase, in an example. The DC decoupling component 120 of FIGS. 1A-1B may be a capacitor 210, as shown in FIG. 2A. The capacitor 210 decouples the DC component while it allows the AC component to pass through. FIG. 2B is a schematic diagram of multiphase converters 200B where mode of operation for each phase is independent of the other phase, in an example. The DC decoupling component 120 of FIGS. 1A-1B may be a switch 220, as shown in FIG. 2B.

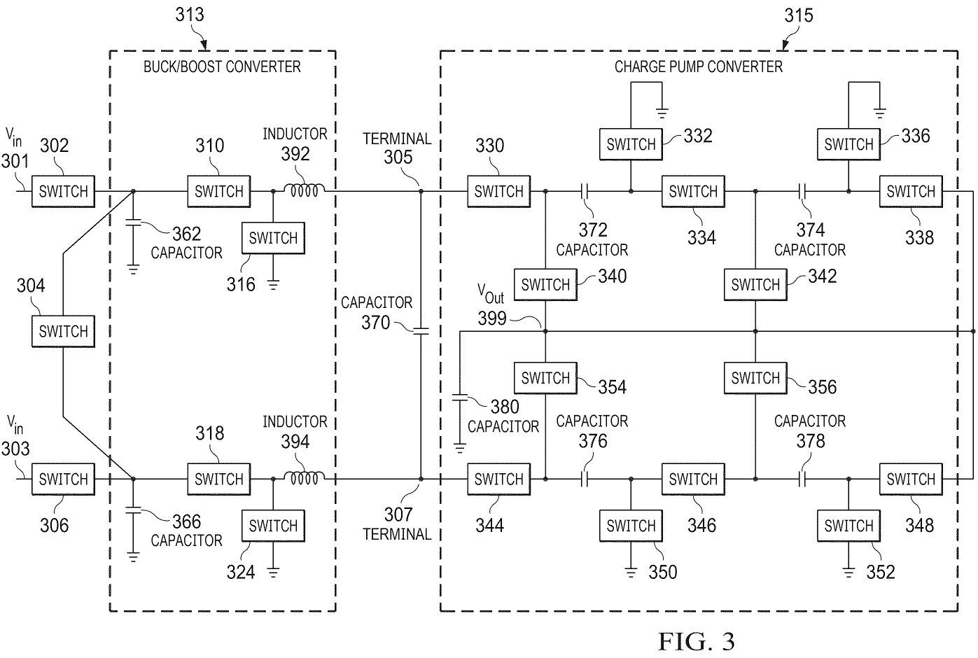

FIG. 3 is a schematic diagram of a cascaded multiphase converter, in an example. In this example, a first converter circuit is a buck/boost converter 313 that is cascaded with a second converter circuit that is a charge pump converter 315. Two converter circuits are shown for illustration purposes and should not be construed as limiting the scope. For example, three or more converter circuits may be cascaded with one another. In this example, the buck/boost converter 313 may be a 2-level dual phase converter and the charge pump converter 315 may be a three to one or two to one configurable charge pump that operates to increase efficiency across range of duty cycle. In this example, the clock frequency may be selected for the 2-level buck/boost converter and charge pump converter to improve efficiency. In this example, the buck/boost converter 313 may be a dual phase converter for illustrative purposes and should not be construed as limiting the scope. For example, the buck/boost converter 313 may be implemented as a three or more level phase converter in some examples. It is appreciated that the embodiments are described with respect to a 2-level buck/boost converter for illustration purposes only and should not be construed as limiting the scope of the embodiments. For example, a 3-level buck/boost converter may be used.

The buck/boost converter 313 may include two input terminals (one for each phase) and two output terminals (one for each phase), e.g., terminals 305 and 307. One output terminal 305 of the buck/boost converter 313 is connected to one terminal of the capacitor 370 and another output terminal 307 of the buck/boost converter 313 is connected to another terminal of the capacitor 370. In other words, the capacitor 370 is connected between the two output terminals 305 and 307 of the buck/boost converter 313.

The charge pump converter 315 may include two input terminals (one for each phase) and an output terminal. One input terminal of the charge pump converter 315 is connected to the output terminal 305 of the buck/boost converter 313 and also to a first terminal of the capacitor 370. Another input terminal of the charge pump converter 315 is connected to the other output terminal 307 of the buck/boost converter 313 and further to the second terminal of the capacitor 370. Accordingly, the capacitor 370 is a DC decoupling component to DC disconnect the first phase from the second phase (but enabling ripple current to go through), thereby enabling the multiphase cascaded converters to be operated in multiple power paths.

In this example, the buck/boost converter 313 and the charge pump converter 315 deliver target performance for the two power inputs, e.g., Vᵢₙ 301 and Vᵢₙ 303, operating conditions while reducing the area and external components. According to an example, the efficiency and power density is increased by using small and low-profile inductors 392 and 394. One output terminal of the buck/boost converter 313 is connected to one terminal of the capacitor 370 to one input terminal of the charge pump converter 315. Similarly, a second output terminal of the buck/boost converter 313 is connected to the second terminal of the capacitor 370 to the second input terminal of the charge pump converter 315. Cascading the two converters in the topology as described above facilitates independent single-phase buck and boost operation without a need to use disconnect/bypass switches. For example, the power inputs Vᵢₙ 301 and Vᵢₙ 303 operate in one or two phase modes and each phase may operate in buck or boost mode independently.

The topology of the buck/boost converter 313 and the charge pump converter 315 are provided for illustration purposes and should not be construed as limiting the scope. In one example, the power input Vᵢₙ 301 is connected to a switch 302 to a first input terminal of the buck/boost converter 313. The switch 302 and the first input terminal are also connected to the second input terminal of the buck/boost converter 313 via a switch 304. The power input Vᵢₙ 303 is routed to the second input terminal of the buck/boost converter 313 via the switch 306. In this example, the buck/boost converter 313 is a dual phase converter (having an upper path (first phase) and a lower path (second phase)). The upper path is connected to the first input terminal and includes a capacitor 362 that is grounded from one end (terminal) and connected to a switch 310 and the first input terminal from the other end (terminal). The switch 310 is connected to the switch 316 (switch 316 is grounded) and also to one terminal of the inductor 392. The output of the inductor 392 at terminal 305 is the output from the first phase of the buck/boost converter 313.

The second phase of the buck/boost converter 313 mirrors the first phase (lower path mirrors the upper path) and includes the capacitor 366, switches 318 and 324, and inductor 394. As illustrated the buck/boost converter 313 topology is a 2-level dual-phase converter and is provided for illustration purposes without limiting the scope of the examples. For example, more than two phase topology may be used by duplicating a single path without the need for any additional switches while enabling each phase to operate independently in buck or boost mode, as will be discussed later. Moreover, a multi-level (e.g., 3-level) converter may be used instead of 2-level and discussions with respect to 2-level is for illustrative purposes only and should not be construed as limiting the scope of the examples.

The output terminal 305 of the buck/boost converter 313 is connected to one terminal of the capacitor 370 while the output terminal 307 of the buck/boost converter 313 is connected to the second terminal of the capacitor 370. In one example, the terminal 305 of the buck/boost converter 313 is connected to a first input terminal of the charge pump converter 315 and the terminal 307 of the buck/boost converter 313 is connected to a second input terminal of the charge pump converter 315. As such, the capacitor 370 DC decouples the first phase from the second phase, enabling each phase to operate independently from one another.

The charge pump converter 315 may include switches and capacitors associated with each phase. For example, switches 330-342 and capacitors 372-374 correspond to a first phase while switches 344-356 and capacitors 376-378 correspond to a second phase. The output of switches 340 and 342 is connected to the output of switches 354 and 356, and are connected to one terminal of a capacitor 380 while another terminal of the capacitor 380 is grounded. The output voltage from the charge pump converter 315 is Vₒᵤₜ 399. The topology for the charge pump converter 315 is for illustration purposes and should not be construed as limiting the scope of the example. In one example, the charge pump converter 315 is configurable between 3:1 and 2:1 ratio. For example, while all switches of the charge pump converter 315 are switching for 3:1 ration, the charge pump converter 315 may be configured to 2:1 by keeping switches 338 and/or 348 off while keeping switches 334/342 and/or 356/346 on while other switches are toggling.

In the provided example above, the charge pump is integrated into each phase of the buck/boost converter 313. As illustrated, placement of the capacitor 370 between the two output terminals of the buck/boost converter 313 and further between the two input terminals of the charge pump converter 315 DC decouples the two phases, as opposed to be being shorted as it is done in the conventional system. As such, the topology of this example supports a single-phase buck and single-phase boost, or two independent boost or buck functions, or two simultaneous boost or buck functions, for the power inputs Vᵢₙ 301 and Vᵢₙ 303. Moreover, the topology of this example enables the current to be controlled at the terminals 305 and 307 instead of the voltage as is done in the conventional system. Controlling the current through the terminals 305 and 307 enables a single feedback loop to be used to control the output from the cascaded converters rather than having to control the output of each converter independent from one another. In other words, the output of the cascaded converters is controlled using a single control loop by regulating the current generated for each phase of the buck/boost converter 313 rather than having to regulate the output voltage of the buck/boost converter 313 and then regulating the output of the charge pump converter 315 separately, thereby eliminating the need to regulate the intermediate output voltage of each converter.

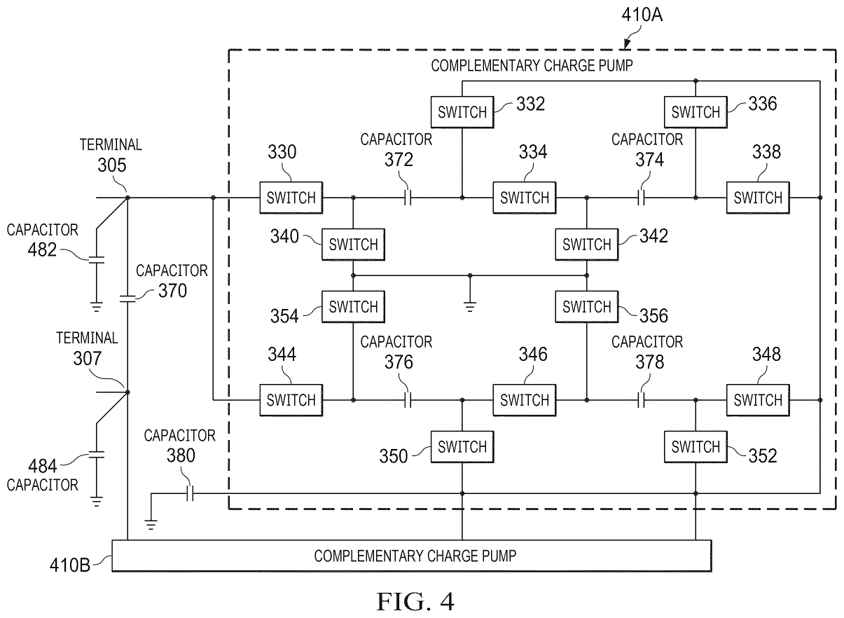

FIG. 4 is a schematic diagram of complementary charge pump 410A and 410B for each phase of a cascaded multiphase converters, in an example. A complementary charge pump topology for each phase reduces losses through the capacitors 482-484 by enabling smaller capacitors with higher efficiency to be used. The complementary charge pump 410A has the same topology as the charge pump converter 315 for each phase except that switches 332 and 336 and 350 and 352 are connected to one another and further connected to switches 338 and 348 and further to the capacitor 380 instead of switches 332, 336, 350, and 352 being grounded. Moreover, instead of switches 340, 342, 354, and 356 being connected to one another and further connected to the capacitor 380 they are now grounded. Moreover, switches 330 and 344 are connected to terminal 305 instead of each of them being connected to one input terminal of the charge pump 315. The terminal 305 is connected to switches 330 and further connected to one terminal of the capacitor 370 and further connected to one terminal of the capacitor 482 that is grounded. In one example, the topology of complementary charge pump 410B associated with the second phase of the buck/boost converter 313 has a similar topology as that of complementary charge pump 410A.

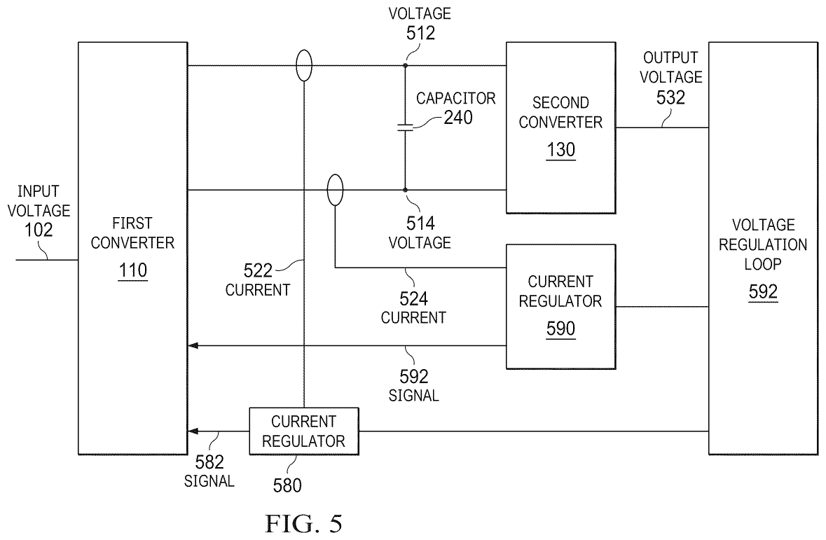

FIG. 5 is a schematic diagram of a feedback loop controlling the output voltage of a cascaded multiphase converters by regulating the output current from an initial and/or intermediate converter in the cascaded multiphase converters, in an example. The first converter 110 circuit may be cascaded with the second converter 130, as described in FIGS. 1A-2B, via the DC decoupling component such as the capacitor 240. In one example, the first converter 110 circuit may be a buck/boost converter and may have a topology similar to that described in FIG. 3 and the second converter 130 circuit may be a charge pump converter that may have a topology similar to that described in FIG. 3 or 4. As described above the capacitor 240 DC decouples the voltages 512 and 514 at each input terminal of the second converter 130 circuit. Unlike the conventional system that the intermediate voltage is regulated, in this example, the current is being regulated. In an example, the output signal from the second converter 130 circuit is provided to a voltage regulation loop 592 where the output voltage 532 is compared to a target voltage. The voltage regulation loop 592 outputs a feedback signal to the current regulators 580 and 590 respectively, based on the comparison. The feedback signal may have an output voltage 532 at the output terminal of the second converter 130 circuit. The current regulator 590 may cause the current 524 through the second phase of the first converter 110 circuit to be controlled (e.g., increased/decreased) whereas the current regulator 580 may cause the current 522 through the first phase of the first converter 110 circuit to be controlled via signals 592 and 582 respectively. In an example, the signal 582 may control the current through the first phase of the first converter 110 circuit by controlling (e.g., turning on/off) switches 310-316, as shown in FIG. 3. In an example, the signal 592 may control the current through the second phase of the first converter 110 circuit by controlling (e.g., turning on/off) switches 318-324, as shown in FIG. 3. As such, the current through the output terminals 305 and 307 terminals of the first converter 110 circuit is controlled using a single feedback loop rather than having to control the output (e.g., intermediate output voltage) of each converter independent from one another. In this example, two cascaded converters are shown for illustrative purposes but should not be construed as limiting the scope of the examples. Advantages of a single control loop increases as the number of converters in a cascaded topology increases because instead of using multiple control loops (e.g., one for each converter), the topology as described above, enables a single control loop to control the entire cascaded converters.

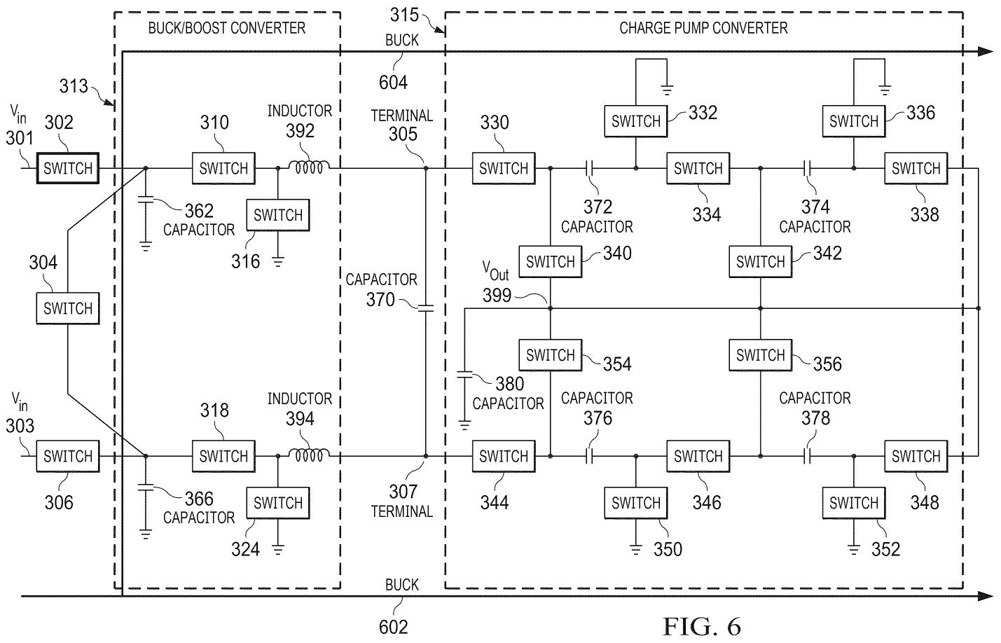

FIGS. 6-10 is the operation of each phase of the cascaded multiphase converters, in an example. In FIG. 6, the cascaded multiphase converters of FIG. 3 are shown that operate in a dual phase buck mode. In an example, the switch 302 may be turned off (switches illustrated in an off state are illustrated in gray in the figures). As such, the power input Vᵢₙ 301 does not go through the converters whereas the power input Vᵢₙ 303 is routed through the cascaded converters. In this example, the power input Vᵢₙ 303 goes through the second phase of the buck/boost converter 313 as well as the first phase of the buck/boost converter 313 because the switch 302 is off and switch 304 is on. As such, each phase of the cascaded converters operates in a buck mode, e.g., buck 602 and 604. The arrows, illustrate direction of the input to output in order for the circuit to operate in various modes. For example, in FIG. 6, the input is from Vᵢₙ 303 since the switch 302 is off, and the both phases of the circuit operate in buck mode, e.g., buck 602 and 604.

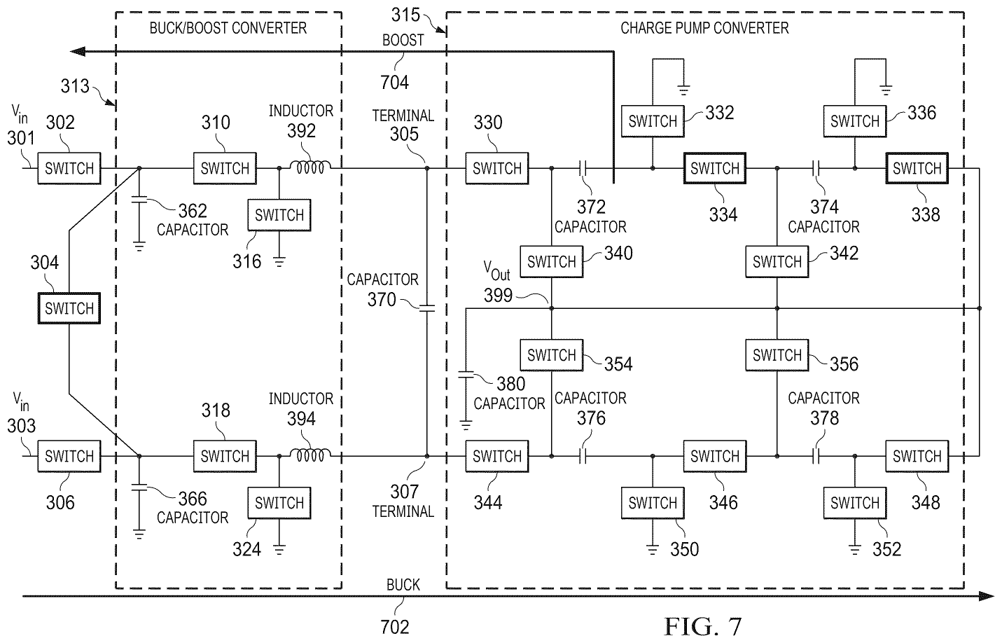

Referring now to FIG. 7, the cascaded multiphase converters of FIG. 3 are shown where the first phase of the cascaded converters operates in a boost 704 mode and where the second phase operates in a buck mode 702. For example, switch 304 may be turned off, as such the power inputs Vᵢₙ 301 and Vᵢₙ 303 of the first and the second phase travel through the first phase and the second phase of the buck/boost converter 313 circuit independently. Switches 334 and 338 of the charge pump converter 315 are off, causing the charge pump converter 315 to be in a bypass mode and result in the first phase to operate in a boost mode, as shown. In comparison, the charge pump converter 315 operates in a normal mode (e.g., not in a bypass mode) for the second phase. The charge pump converter 315 may be configured to operate as a 2:1 (enabling the output voltage to be approximately half of the input voltage) or 3:1 (enabling the output voltage to be approximately one third of the input voltage) charge pump or operate in a bypass mode, as illustrated.

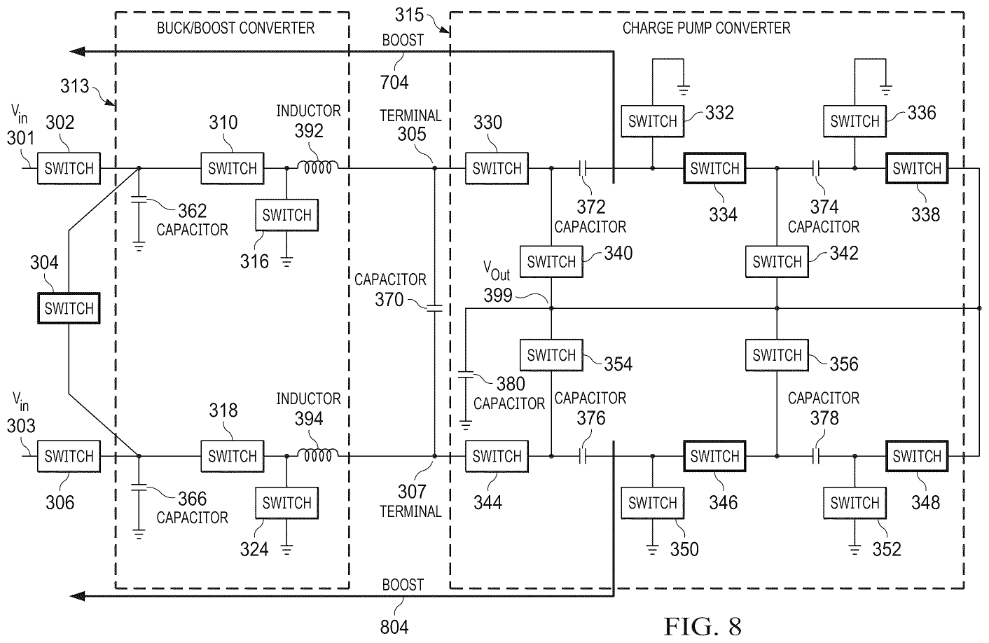

Referring now to FIG. 8, the cascaded multiphase converters of FIG. 3 are shown where the first phase and the second phase each operate in a boost mode, independent of one another. In this example, the switches 334 and 338 are turned off causing the charge pump converter 315 to operate in a bypass mode for the first phase. Similarly, the switches 346 and 348 are turned off causing the charge pump converter 315 to operate in a bypass mode for the second phase.

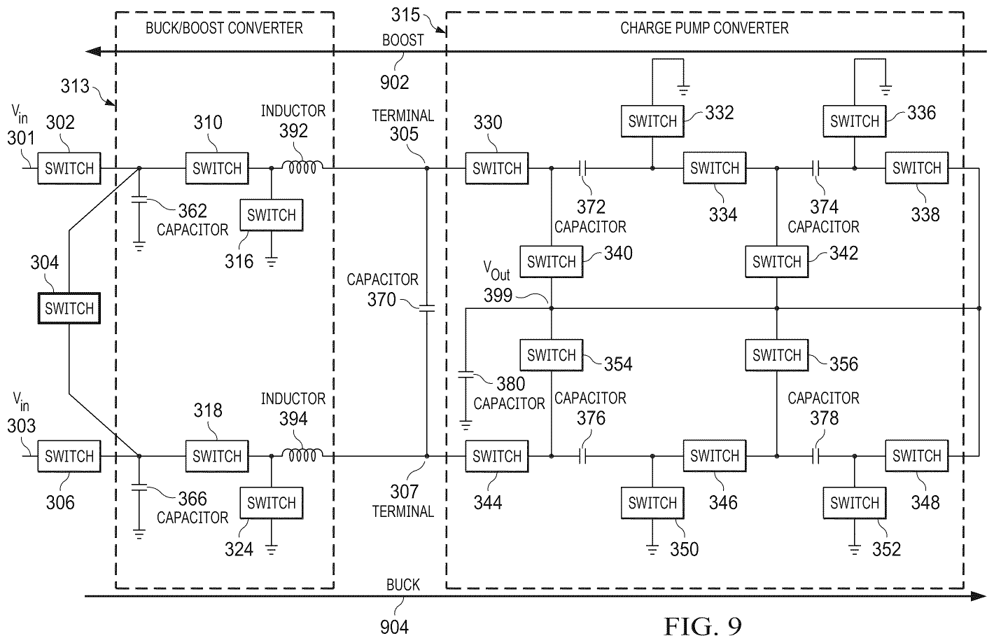

Referring now to FIG. 9, the cascaded multiphase converters of FIG. 3 are shown where the first phase operates in a boost 902 mode and the second phase operates in a buck 904 mode. In this example, switch 304 is turned off and the charge pump operates in its normal mode (e.g., not in a bypass mode). It is appreciated that both phases, in one nonlimiting example, are operating as charge pump where one phase of charge pump boosts the Vₒᵤₜ 399 of the charge pump converter 315 to terminal 305 and where the other phase bucks terminal 307 to Vₒᵤₜ 399 level.

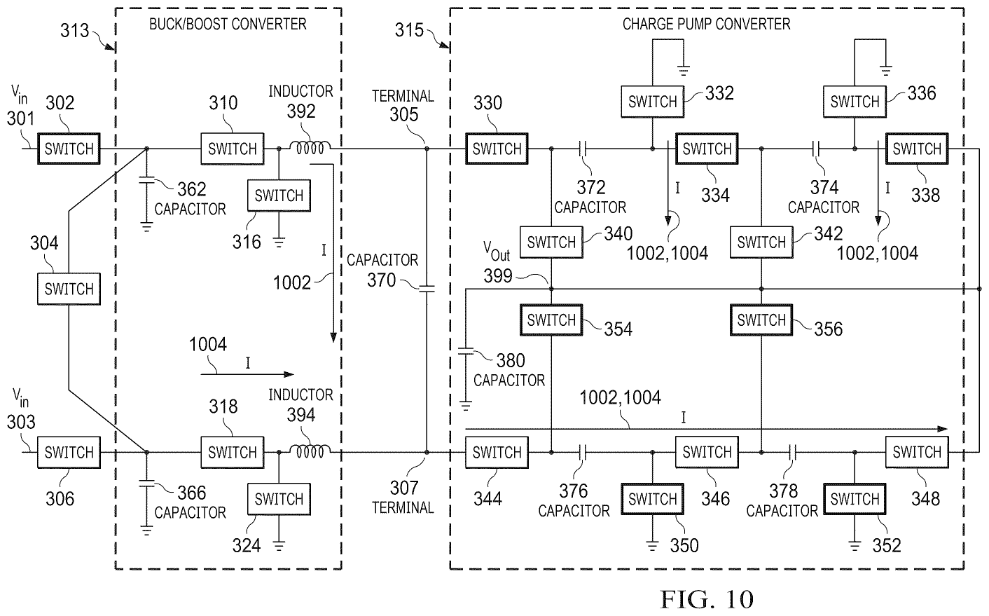

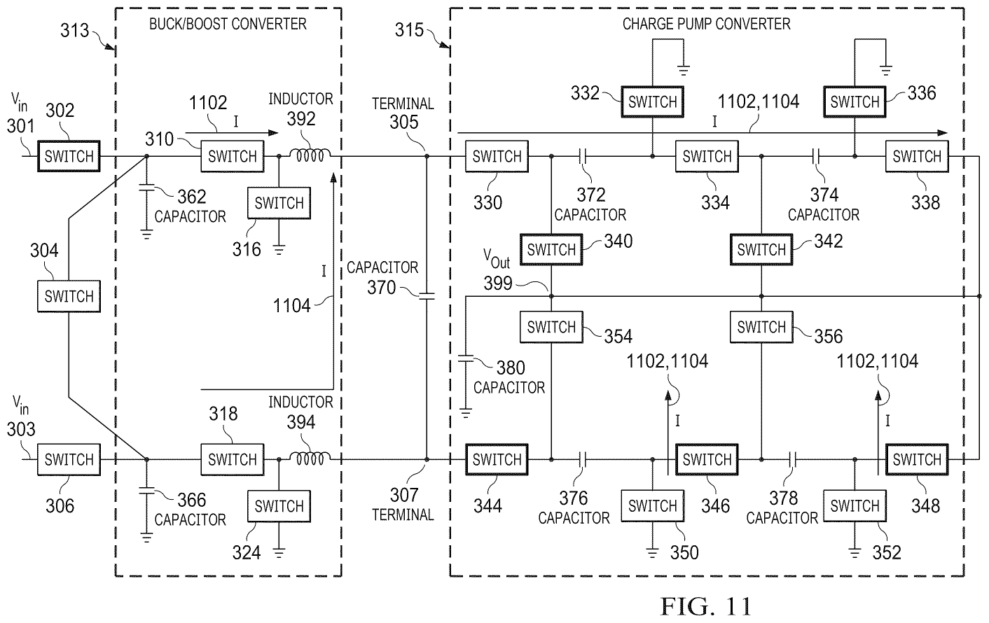

FIGS. 10-11 are schematic diagrams of the cascaded multiphase converters and a current flow, in an example. Referring to FIG. 10, switches 302, 330, 334, 338, 354, 356, 350, and 352 are turned off. As such, the current 1002 from the first phase of the buck/boost converter 313 flows through to the second phase where current 1004 also flows resulting in a total current of I 1002 plus I 1004 to flow through switches 344, 346, 348, and capacitors 376-378 and operate in a charge state. In comparison, current I 1002 plus I 1004 flows through switch 332, capacitor 372, and switch 349 in a discharge state to Vₒᵤₜ 399. Similarly, current I 1002 plus I 1004 flows through switch 336, capacitor 374 and switch 342 in a discharge state to Vₒᵤₜ 399.

Referring to FIG. 11, switches 302, 332, 336, 340, 342, 344, 346, and 348 are turned off. As such, the current 1104 from the second phase of the buck/boost converter 313 flows through the first phase because switch 344 is turned off. Accordingly, the current through the terminal 305 of the buck/boost converter 313 is I 1102 plus 1104 that flows through switches 330, 334, 338 and capacitors 372 and 374 in a charge state. In comparison, current I 1102 plus 1104 flows through switch 350 capacitor 376 and switch 354 to Vₒᵤₜ 399 in a discharge mode. Similarly, current I 1102 plus 1104 flows through switch 352 capacitor 378 and switch 356 to Vₒᵤₜ 399 in a discharge mode. It is appreciated that the current waveform through switches 350 and 354 or 352 may be nonlinear and may depend on the board and capacitor parasitics while the transferred charges is the same in each phase.

As illustrated, the DC decoupling component such as a capacitor that is not shorted has been used to decouple the two or more phases of the cascaded converters from one another. As such, each phase of the converter may be operated independently, as illustrated in FIGS. 6-9 for example. Moreover, the configuration as described above has enabled a single control loop to be used to control the current output for each phase of the first converter to regulate the output voltage of the last converter of the cascaded converters, rather having to control the voltage output for each converter of the cascaded converters.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

Modifications are possible in the described embodiments, and other embodiments are possible, within the scope of the claims.

What is claimed is:

1. An apparatus comprising:
a first converter circuit with a first output terminal and a second output terminal;
a second converter circuit with a first input terminal and a second input terminal and a third output terminal, wherein a first connection connects the first output terminal to the first input terminal, and wherein a second connection connects the second output terminal to the second input terminal; and
a direct current (DC) decoupling component that is connected between the first connection and the second connection, wherein the DC decoupling component DC decouples a signal between the first connection and the second connection.

2. The apparatus of claim 1, wherein the DC decoupling component is a capacitor.

3. The apparatus of claim 1, wherein the DC decoupling component is a switch.

4. The apparatus of claim 1, wherein the first converter is a buck/boost converter circuit.

5. The apparatus of claim 1, wherein the second converter is a charge pump converter circuit.

6. The apparatus of claim 1, wherein:
the second converter circuit is configured to output a feedback signal from the third output terminal;
the feedback signal is configured to regulate a current output from the first output terminal and the second output terminal; and
the current is generated from the first converter circuit.

7. The apparatus of claim 6, wherein the current generated from the first converter circuit regulates a voltage output by the second converter circuit.

8. The apparatus of claim 1, wherein the first converter circuit and the second converter circuit include multiple phases, and wherein a first phase of the first converter circuit and the second converter circuit operates independently from a second phase of the first converter circuit and the second converter circuit.

9. The apparatus of claim 8, wherein the first phase operates in a buck mode and wherein the second phase operates in a boost mode.

10. The apparatus of claim 8, wherein the first and the second phase each operate in a buck mode independent of one another.

11. The apparatus of claim 8, wherein the first and the second phase each operate in boost mode independent of one another.

12. An apparatus comprising:
a buck/boost converter;
a charge pump converter, wherein the buck/boost converter and the charge pump converter are cascaded with one another; and
a capacitor, wherein a first terminal of the capacitor is connected to a first output of a first cascaded converter circuit and a second terminal of the capacitor is connected to a second output of the first cascaded converter circuit, and wherein the first output of the first cascaded converter circuit is a first input to a second cascaded converter circuit and wherein the second output of the first cascaded converter circuit is a second input to the second cascaded converter circuit.

13. The apparatus of claim 12, wherein:
the second cascaded converter circuit is configured to output a feedback signal from an output of the cascaded converter circuits;
the feedback is configured to regulate a current output from the first cascaded converter circuit; and
the current is generated from the first cascaded converter circuit.

14. The apparatus of claim 12, wherein the current generated from the first cascaded converter circuit regulates a voltage output by the second cascaded converter circuit.

15. The apparatus of claim 12, wherein the buck/boost converter includes multiple phases and wherein the charge pump converter includes multiple phases, and wherein a first phase of the buck/boost converter and the charge pump converter operates independently from a second phase of the buck/boost converter and the charge pump converter.

16. The apparatus of claim 15, wherein the first phase operates in a buck mode and wherein the second phase operates in a boost mode.

17. The apparatus of claim 15, wherein the first and the second phase each operate in a buck mode independent of one another.

18. The apparatus of claim 15, wherein the first and the second phase each operate in boost mode independent of one another.

19. The apparatus of claim 15, wherein each phase associated with the buck/boost converter has a complementary charge pump associated therewith.

20. The apparatus of claim 15, wherein the buck/boost converter includes a first input terminal and a second input terminal, wherein the first input terminal receives a first voltage input and the second input terminal receives a second voltage input, and wherein the first and the second input terminals are selectable.
